(19) United States
(12) Patent Application Publication
(10) Pub. No.: US 2026/0137130 A1
(43) Pub. Date: May 21, 2026

(54) AEROSOL GENERATING DEVICE

(71) Applicant: Nicoventures Trading Limited, London (GB)

(72) Inventors: Richard HEPWORTH, London (GB); Mark AUSTIN, London (GB)

(21) Appl. No.: 19/121,847

(22) PCT Filed: Oct. 19, 2023
(86) PCT No.: PCT/EP2023/079164

§ 371 Date: Apr. 17, 2025

(30) Foreign Application Priority Data
Oct. 21, 2022 (GB) 2215588.1

(51) Int. Cl. A24F 40/57; A24F 40/46; A24F 40/51; H05B 3/26

(52) U.S. Cl. CPC A24F 40/57; A24F 40/46; A24F 40/51; H05B 3/26; H05B 2203/005

(57) ABSTRACT

An aerosol provision device (6) for generating an aerosol from aerosol generating material (26) is disclosed. The device (6) comprises a plurality of aerosol generators (46), and a controller (34), in which the aerosol generators (46) are disposed adjacent to each other to form an array of aerosol generators (46). The device (6) is so configured that the aerosol generating material (26) is positioned to overlie the array of aerosol generators (46). Each aerosol generator (46) is configured to generate aerosol from a generation area (56) of the aerosol-generating material (26) when the aerosol generator (46) is fully activated, and the generation areas (56) associated with aerosol generators (46) adjacent to each other in the array abut, partially overlap, or are adjacent to each other.

### CROSS-REFERENCE TO RELATED APPLICATIONS

This application is a National Stage entry of PCT/EP2023/079164, filed 19 Oct. 2023, which claims priority from GB 2215588.1, filed 21 Oct. 22, each of which are hereby incorporated by reference in their entireties.

### TECHNICAL FIELD

The present disclosure relates to aerosol generating device for generating an aerosol from aerosol-generating material and a system comprising an aerosol generating device and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure there is provided an aerosol generating device for generating an aerosol from aerosol-generating material. The device comprises a plurality of aerosol generators, and a controller. The aerosol generators are disposed adjacent to each other to form an array of aerosol generators, and the device is so configured that the aerosol generating material is positioned to overlie the array of aerosol generators. Each aerosol generator is configured to generate aerosol from a generation area of the aerosol-generating material when the aerosol generator is fully activated and the generation areas associated with aerosol generators adjacent to each other in the array, abut, partially overlap, or are adjacent to each other.

The aerosol generating material overlies the array of aerosol generators when a surface of the aerosol generating material is in contact with or close to a surface of the array of aerosol generators such that full activation of the aerosol generators can cause generation of aerosol from the aerosol generating material.

In an embodiment of the above embodiment, an aerosol generator is fully activated when it is in its intended maximum aerosol generating state. For an aerosol generator which generates heat to cause aerosolization of the aerosol generating material, full activation is when the aerosol generator is at its maximum intended temperature.

In an embodiment of any of the above embodiments, an aerosol generator which generates heat to cause aerosolization of the aerosol generating material may cause generation of aerosol at some levels of activation which are less than full activation.

In some embodiments the aerosol generator can be activated to a level which is less than full activation that pre-heats but does not aerosolise the aerosol generating material.

An advantage of the aerosol provision device of the present disclosure is that the abutment or partial overlapping of the generation areas has the result that there is a maximised aerosolisation of the aerosol generating material. This is because there are no portions of non-aerosolised aerosol generating material between the areas which have been aerosolised.

A further advantage is that the efficient aerosolisation of the aerosol generating material allows a minimisation of the size of the aerosol generating material.

A further advantage is that in embodiments where the aerosol generator generates heat to cause aerosolization of the aerosol generating material, the heating of a first area of aerosol generating material by a first aerosol generator will, in addition to generating aerosol from the first area, warm at least part of the adjacent area(s) of aerosol generating material because of thermal conduction through the aerosol generating material. This has the effect of reducing the energy needed to aerosolise the adjacent area(s) of aerosol generating material if they are to be aerosolised soon after the first area.

In an embodiment of any of the above embodiments, each of the aerosol generators are of the same dimensions as each other.

In an alternative embodiment of any of the above embodiments at least one aerosol generator is differently dimensioned relative to the other aerosol generators.

In an embodiment of any of the above embodiments, the controller controls the order in which the aerosol generators are activated, and the controller fully activates the aerosol generators sequentially from the aerosol generator at a first position on the array of aerosol generators to an aerosol generator at a second position on the array of aerosol generators. The first and second positions on the array of aerosol generators may be at first and second ends of the array if the array is longitudinally extending or may be at other positions in the array of aerosol generators.

The sequential activation of the aerosol generators is activation in a predetermined order. That predetermined order is, in some embodiments, determined by the aerosol generators being adjacent to each other. In other embodiments the aerosol generators adjacent to each other in the sequence are not physically adjacent to each other in the array of aerosol generators.

In an embodiment of any of the above embodiments, the predetermined order of activation of each aerosol generator is an order that is determined by the positioning of the aerosol generators relative to each other.

In an embodiment of any of the above embodiments, the predetermined order of activation of each aerosol generator is an order that is determined by one or more of the dimensions, shape, surface area, or other feature of the aerosol generators.

In an embodiment of any of the above embodiments, each aerosol generator activated by the controller is, after the first activated aerosol generator, adjacent to the previously activated aerosol generator.

In an embodiment of any of the above embodiments, the array of aerosol generators extends in a longitudinal direction between a first longitudinal end and a second longitudinal end. In some embodiments the longitudinal direction extends between a proximal end and a distal end. The proximal end is, in some embodiments a mouth piece for the aerosol provision device, or adjacent a mouth piece for the aerosol provision device.

In an embodiment of any of the above embodiments, the first position is at the first longitudinal end and the second position at the second longitudinal end.

In an embodiment of any of the above embodiments, each aerosol generator is configured to warm but not aerosolize a warming area of aerosol-generating material when that aerosol generator is fully activated; and the warming area associated with a given aerosol generator at least partially surrounds the generation area for that aerosol generator.

In an embodiment of any of the above embodiments, the warming area associated with a first aerosol generator at least partially overlies the generation area of a second aerosol generator, in which the second aerosol generator is adjacent to the first aerosol generator and closer to the second position on the array than the first aerosol generator.

In an embodiment of any of the above embodiments, each aerosol generator is configured to warm but not aerosolize the generation area of aerosol-generating material of that aerosol generator when that aerosol generator is partially activated. The partial activation causes the aerosol generator to reach a temperature below the aerosolisation temperature of the aerosol generating material.

In an embodiment of any of the above embodiments, the array of aerosol generators forms a longitudinally extending rod, or the array of aerosol generators is supported on the surface or one or more surfaces of a longitudinally extending support rod to form a longitudinally extending rod.

In an embodiment of any of the above embodiments, the array of aerosol generators has a longitudinal dimension of two or more aerosol generators and a lateral dimension of one aerosol generator.

In an embodiment of any of the above embodiments, each aerosol generator is formed as a closed loop and configured to extend around a longitudinally extending rod.

In an embodiment of the above embodiment, the closed loop has one of a circular, elliptical, rectangular, or other polyhedral shape.

In an embodiment of any of the above embodiments, the array of aerosol generators has a longitudinal dimension of two or more aerosol generators and a lateral dimension of two or more aerosol generators.

In an embodiment of any of the above embodiments, the generation areas associated with the aerosol generators abut or partially overlap each other in both the longitudinal and lateral directions.

In an embodiment of any of the above embodiments, the controller controls the order in which the aerosol generators are activated, and the controller fully activates the aerosol generators in a sequence from at least one aerosol generator at the first position on the array to at least one aerosol generator at the second position on the array.

In an embodiment of any of the above embodiments, at least one intermediate part of the sequence in which the aerosol generators are fully activated is activation of an aerosol generator that is longitudinally closer to the second position on the array than the previously activated aerosol generator and laterally in the same position as the previously activated aerosol generator.

An intermediate part of the sequence is a part between the full activation of the first aerosol generator in the sequence and the full activation of the last aerosol generator in the sequence.

In an embodiment of any of the above embodiments, at least one intermediate part of the sequence in which the aerosol generators are fully activated is activation of an aerosol generator that is longitudinally substantially the same distance from the second position on the array as the previously activated aerosol generator and laterally spaced from the position of the previously activated aerosol generator.

In an embodiment of any of the above embodiments, at least one intermediate part of the sequence in which the aerosol generators are fully activated is activation of an aerosol generator that is longitudinally closer to the second position on the array than the previously activated aerosol generator and laterally spaced from the position of the previously activated aerosol generator.

In an embodiment of any of the above embodiments, the controller further controls the number of aerosol generators that are fully activated at any given time.

In an embodiment of any of the above embodiments, the controller is configured to partially activate one or more aerosol generators as part of the sequence of fully activating the aerosol generators.

In an embodiment of any of the above embodiments, the array of aerosol generators comprises at least one printed circuit board supporting a plurality of individually heatable circuits.

In an embodiment of the above embodiment, at least one of the printed circuit boards comprises a flexible printed circuit board.

In an embodiment of any of the above embodiments, at least one of the aerosol generators comprises an electrical resistance heater.

In an embodiment of any of the above embodiments, at least one of the aerosol generators comprises an etched film or a printed film heater.

In an embodiment of any of the above embodiments the array of aerosol generators comprises a plurality of resistive tracks or traces supported or deposited on a carrier.

In an embodiment of any of the above embodiments, the predetermined order of activation of each track or trace is an order that is determined by the positioning of the tracks or traces relative to each other.

In an embodiment of any of the above embodiments, the predetermined order of activation of each track or trace is an order that is determined by one or more of the dimensions, shape, surface area, composition or other feature of the tracks or traces.

In an embodiment of any of the above embodiments, the carrier is planar or approximately flat.

In an embodiment of any of the above embodiments, each of the tracks or traces is located on one surface of the carrier.

In an embodiment of any of the above embodiments, at least one of the aerosol generators comprises an induction coil

In an embodiment of the above embodiment at least one of the aerosol generators comprises a susceptor.

In an embodiment of any of the above embodiments, the controller comprises a memory and a processor, and one or more schedules for the full activation of the aerosol generators in the array of aerosol generators are stored in the memory.

In an embodiment of any of the above embodiments, the memory causes the controller to fully activate a first aerosol generator on receipt of a first input by the controller, and to sequentially fully activate all of the remainder of the aerosol generators in a predetermined order until all of the aerosol generators have been fully activated.

In an embodiment of any of the above embodiments, a schedule stored in the memory divides the aerosol generators into a non-zero number (n) of groups of aerosol generators and allocates the groups a number from 1 to n, in which each group of aerosol generators contains a non-zero number of aerosol generators, and the schedule comprises instructions to cause the controller to fully activate the aerosol generators of group 1 according to a first sub-schedule on receipt of a first input by the controller, to fully activate the aerosol generators of group 2 according to a second sub-schedule on receipt of a second input by the controller, and to repeat that pattern until the aerosol generators of group n have been fully activated according to an nth sub-schedule on receipt of an nth input by the controller.

In an embodiment of the above embodiment, each of the sub-schedules 1 to n are the same.

In an embodiment of any of the above embodiments, the number of aerosol generators in each of groups 1 to n is the same.

In an embodiment of any of the above embodiments, the schedule includes instructions relating each individual aerosol generator with a period of time for which that aerosol generator is to be fully activated.

In an embodiment of any of the above embodiments, the period of time for which each individual aerosol generator is activated is the same.

In an embodiment of any of the above embodiments, the device comprises a puff detection means, the puff detection means is in communication with the controller, the puff detection means is configured to detect a characteristic of a puff, the puff detection means is configured to generate a signal on detection of the characteristic of the puff, and the signal is transmitted to the controller.

In an embodiment of any of the above embodiments, the detected characteristic of the puff is one of the start of the puff, the end of the puff, the period of time between the start and end of the puff, the number of puffs per predetermined period of time, the period between puffs, the drop of air pressure at the puff detection means resultant from the puff, the velocity of air passing the puff detector at a determined time in the period of the puff, the volume of the puff.

In an embodiment of any of the above embodiments, the puff detection means is configured to detect two or more characteristics of the puff, the puff detection means is configured to generate a different signal on detection of each characteristic of the puff, and the signals are transmitted to the controller.

In an embodiment of any of the above embodiments, the device comprises a plurality of puff detection means, and each puff detection means is in communication with the controller.

In an embodiment of any of the above embodiments, one or more tables are stored in the memory, at least one table relates a characteristic of a puff to a predetermined schedule for the full activation of one or more aerosol generators, and the controller implements the predetermined schedule in response to receipt of a signal generated by the puff detection means on detection of that characteristic of the puff in one or more of the tables.

In an embodiment of any of the above embodiments, the predetermined schedule overrides any schedule that the controller was implementing at the time of receipt of the signal generated by the puff detection means.

In an embodiment of any of the above embodiments, the device further comprises a user operated activation means, for example an activation button.

In an embodiment of any of the above embodiments, the one or more tables include one or more of the following ways to control the activation times for the aerosol generators:
initiating a fixed period of activation on detection of a puff characteristic or input from a user operated activation means.
initiating a flexible period of activation on detection of a puff characteristic or input from a user operated activation means but limited to a maximum period.
initiating a flexible period of activation on detection of a puff characteristic or input from a user operated activation means with the period of activation being controlled by the temperature of the activated aerosol generator or aerosol generators.

In an embodiment of any of the above embodiments, the device further comprises at least one display element, and the controller may cause at least one display element to be activated when an aerosol generator is activated.

In an embodiment of any of the above embodiments, the controller may cause at least one display element to display data relating to the operation of the device.

In an embodiment of any of the above embodiments, the display element is configured to provide a visual representation of a traditional cigarette when the traditional cigarette is burning.

In an embodiment of any of the above embodiments, the display element is configured to provide a visual representation of the proportion of the aerosol generating material that has not yet been aerosolized.

According to a second aspect of the present disclosure there is provided an aerosol provision system comprising an aerosol provision device according to the first aspect of the present disclosure and an article, in which the article comprises aerosol-generating material.

According to a third aspect of the present disclosure there is provided a method of generating aerosol from an aerosol-generating material using an aerosol-generating device. The aerosol provision device comprises a plurality of aerosol generators, and a controller. The aerosol generators are disposed adjacent to each other to form an array of aerosol generators and the device is configured to cause aerosol generating material to overlie the array of aerosol generators. Each aerosol generator generates aerosol from a generation area of aerosol-generating material when the aerosol generator is fully activated, and the generation areas associated with the aerosol generators abut or partially overlap each other.

The aerosol generating material overlies the array of aerosol generators when a surface of the aerosol generating material is in contact with or close to a surface of the array of aerosol generators such that full activation of the aerosol generators can cause generation of aerosol from the aerosol generating material.

In an embodiment of the above embodiment, an aerosol generator is fully activated when it is in its intended maximum aerosol generating state. For an aerosol generator which generates heat to cause aerosolization of the aerosol generating material, full activation is when the aerosol generator is at its maximum intended temperature.

In an embodiment of any of the above embodiments, an aerosol generator which generates heat to cause aerosolization of the aerosol generating material may cause generation of aerosol at some levels of activation which are less than full activation.

In some embodiments the aerosol generator can be activated to a level which is less than full activation that pre-heats does not aerosolise the aerosol generating material.

An advantage of the aerosol provision device of the present disclosure is that the abutment or partial overlapping of the generation areas has the result that there is a maximised aerosolisation of the aerosol generating material. This is because there are no portions of non-aerosolised aerosol generating material between the areas which have been aerosolised.

A further advantage is that the efficient aerosolisation of the aerosol generating material allows a minimisation of the size of the aerosol generating material.

A further advantage is that in embodiments where the aerosol generator generates heat to cause aerosolization of the aerosol generating material, the heating of a first area of aerosol generating material by a first aerosol generator will, in addition to generating aerosol from the first area, warm at least part of the adjacent area(s) of aerosol generating material because of thermal conduction through the aerosol generating material. This has the effect of reducing the energy needed to aerosolise the adjacent area(s) of aerosol generating material if they are to be aerosolised soon after the first area.

In an embodiment of any of the above embodiments, the controller controls the order in which the aerosol generators are activated, and the controller fully activates the aerosol generators sequentially from an aerosol generator at a first position on the array of aerosol generators to an aerosol generator at a second position on the array of aerosol generators. The first and second positions on the array of aerosol generators may be at first and second ends of the array if the array is longitudinally extending or may be at other positions in the array of aerosol generators.

The sequential activation of the aerosol generators is activation in a predetermined order. That predetermined order is, in some embodiments, determined by the aerosol generators being adjacent to each other. In other embodiments the aerosol generators adjacent to each other in the sequence are not physically adjacent to each other in the array of aerosol generators.

In an embodiment of any of the above embodiments, the array of aerosol generators extends in a longitudinal direction between a first longitudinal end and a second longitudinal end.

In an embodiment of any of the above embodiments, the array of aerosol generators extends in a longitudinal direction between a first longitudinal end and a second longitudinal end. In some embodiments the longitudinal direction extends between a proximal end and a distal end. The proximal end is, in some embodiments a mouth piece for the aerosol provision device, or adjacent a mouth piece for the aerosol provision device.

In an embodiment of any of the above embodiments, the first position is at the first longitudinal end and the second position at the second longitudinal end.

In an embodiment of any of the above embodiments, each aerosol generator warms but does not aerosolize a warming area of aerosol-generating material when that aerosol generator is fully activated; and the warming area associated with a given aerosol generator at least partially surrounds the generation area for that aerosol generator.

In an embodiment of any of the above embodiments, the warming area associated with a first aerosol generator at least partially overlies the generation area of a second aerosol generator, in which the second aerosol generator is adjacent to the first aerosol generator and closer to the second position on the array than the first aerosol generator.

In an embodiment of any of the above embodiments, each aerosol generator warms but does not aerosolize the generation area of aerosol-generating material of that aerosol generator when that aerosol generator is partially activated.

In an embodiment of any of the above embodiments, the array of aerosol generators forms a longitudinally extending rod, or the array of aerosol generators is supported on the surface or one or more surfaces of a longitudinally extending support rod to form a longitudinally extending rod.

In an embodiment of any of the above embodiments, the array of aerosol generators has a longitudinal dimension of two or more aerosol generators and a lateral dimension of one aerosol generator.

In an embodiment of any of the above embodiments, each aerosol generator is formed as a closed loop configured to extend around the longitudinally extending rod.

In an embodiment of any of the above embodiments, the closed loop has one of a circular, elliptical, rectangular, or other polyhedral shape.

In an embodiment of any of the above embodiments, the array of aerosol generators has a longitudinal dimension of two or more aerosol generators and a lateral dimension of two or more aerosol generators.

In an embodiment of any of the above embodiments, the generation areas associated with the aerosol generators abut or partially overlap each other in both the longitudinal and lateral directions.

In an embodiment of any of the above embodiments, the controller controls the order in which the aerosol generators are activated, and the controller fully activates the aerosol generators in a sequence from at least one aerosol generator at the first position on the array to at least one aerosol generator at the second position on the array.

In an embodiment of any of the above embodiments, at least one intermediate part of the sequence in which the aerosol generators are fully activated is activation of an aerosol generator that is longitudinally closer to the second position on the array than the previously activated aerosol generator and laterally in the same position as the previously activated aerosol generator.

An intermediate part of the sequence is a part between the full activation of the first aerosol generator in the sequence and the full activation of the last aerosol generator in the sequence.

In an embodiment of any of the above embodiments, at least one intermediate part of the sequence in which the aerosol generators are fully activated is activation of an aerosol generator that is longitudinally substantially the same distance from the second position on the array as the previously activated aerosol generator and laterally spaced from the position of the previously activated aerosol generator.

In an embodiment of any of the above embodiments, at least one intermediate part of the sequence in which the aerosol generators are fully activated is activation of an aerosol generator that is longitudinally closer to the second position on the array than the previously activated aerosol generator and laterally spaced from the position of the previously activated aerosol generator.

In an embodiment of any of the above embodiments, the controller further controls the number of aerosol generators that are fully activated at any given time.

In an embodiment of any of the above embodiments, the controller partially activates one or more aerosol generators as part of the sequence of fully activating the aerosol generators.

In an embodiment of any of the above embodiments, the array of aerosol generators comprises at least one printed circuit board supporting a plurality of individually heatable circuits.

In an embodiment of any of the above embodiments, at least one of the printed circuit boards comprises a flexible printed circuit board.

In an embodiment of any of the above embodiments, at least one of the aerosol generators comprises an electrical resistance heater.

In an embodiment of any of the above embodiments, at least one of the aerosol generators comprises an etched film or a printed film heater.

In an embodiment of any of the above embodiments, at least one of the aerosol generators comprises an induction coil.

In an embodiment of any of the above embodiments, the controller comprises a memory and a processor, and one or more schedules for the full activation of the aerosol generators in the array of aerosol generators are stored in the memory.

In an embodiment of any of the above embodiments, a schedule stored in the memory causes the controller to fully activate a first aerosol generator on receipt of a first input by the controller, and to sequentially fully activate all of the remainder of the aerosol generators in a predetermined order until all of the aerosol generators have been fully activated.

In an embodiment of any of the above embodiments, a schedule stored in the memory divides the aerosol generators into a non-zero number (n) of groups of aerosol generators and allocates the groups a number from 1 to n, in which each group of aerosol generators contains a non-zero number of aerosol generators, and the schedule comprises instructions to cause the controller to fully activate the aerosol generators of group 1 according to a first sub-schedule on receipt of a first input by the controller, to fully activate the aerosol generators of group 2 according to a second sub-schedule on receipt of a second input by the controller, and to repeat that pattern until the aerosol generators of group n have been fully activated according to an nth sub-schedule on receipt of an nth input by the controller.

In an embodiment of any of the above embodiments, each of the sub-schedules 1 to n are the same.

In an embodiment of any of the above embodiments, the number of aerosol generators in each of groups 1 to n is the same.

In an embodiment of any of the above embodiments, the schedule includes instructions relating each individual aerosol generator with a period of time for which that aerosol generator is to be fully activated.

In an embodiment of any of the above embodiments, the period of time for which each individual aerosol generator is to be activated is the same.

In an embodiment of any of the above embodiments, the device comprises a puff detection means, the puff detection means is in communication with the controller, the puff detection means detects a characteristic of a puff, the puff detection means generates a signal on detection of the characteristic of the puff, and the signal is transmitted to the controller.

In an embodiment of any of the above embodiments, the detected characteristic of the puff is one of the start of the puff, the end of the puff, the period of time between the start and end of the puff, the number of puffs per predetermined period of time, the period between puffs, the drop of air pressure at the puff detection means resultant from the puff, the velocity of air passing the puff detector at a determined time in the period of the puff, the volume of the puff.

In an embodiment of any of the above embodiments, the puff detection means detects two or more characteristics of the puff, the puff detection means generates a different signal on detection of each characteristic of the puff, and the signals are transmitted to the controller.

In an embodiment of any of the above embodiments, the device comprises a plurality of puff detection means, and each puff detection means is in communication with the controller.

In an embodiment of any of the above embodiments, one or more tables are stored in the memory, at least one table relates a characteristic of the puff to a predetermined schedule for the full activation of one or more aerosol generators, and the controller implements the predetermined schedule in response to receipt of a signal generated by a puff detection means on detection of that characteristic of the puff.

In an embodiment of any of the above embodiments, the predetermined schedule overrides any schedule that the controller was implementing at the time of receipt of the signal generated by the puff detection means.

In an embodiment of any of the above embodiments, the device further comprises at least one display element, and the controller may cause at least one display element to be activated when an aerosol generator is activated.

In an embodiment of any of the above embodiments, the controller may cause at least one display element to display data relating to the operation of the device.

In an embodiment of any of the above embodiments, the display element provides a visual representation of a traditional cigarette when the traditional cigarette is burning.

In an embodiment of any of the above embodiments, the display element provides a visual representation of the proportion of the aerosol generating material that has not yet been aerosolized.

The apparatus of the first, second, and third aspects of the present disclosure can include one or more, or all, of the features described above, as appropriate. The method of the third aspect of the present disclosure can include one or more, or all, of the features described above, as appropriate.

### BRIEF DESCRIPTION OF THE DRAWINGS

The present disclosure will now be described, by way of example only, and with reference to the accompanying drawings in which:

FIG. 1 shows a schematic front view of an embodiment of an aerosol generating system according to the present disclosure;

FIG. 2 shows a schematic front and perspective view of an embodiment of an article for use with the aerosol generating system of FIG. 1;

FIG. 3 shows a partially cut away view of the article of FIG. 2;

FIG. 4 shows a schematic front view of the aerosol generating device of the aerosol generating system of FIG. 1;

FIG. 5 shows a schematic sectional view of the aerosol generating system of FIG. 1;

FIG. 6 shows a first schematic enlarged view of part of the sectional view of FIG. 5;

FIG. 7 shows a schematic view of a part of an array of aerosol generators of the aerosol generating device of FIG. 4;

FIG. 8 shows a second enlarged schematic view of part of the aerosol generating system of FIG. 1;

FIG. 9 shows a third enlarged schematic view of part of the aerosol generating system of FIG. 1;

FIG. 10 shows a schematic view of a first embodiment of an array of aerosol generators of the aerosol generating device of FIG. 4;

FIG. 11 shows a schematic view of a second embodiment of an array of aerosol generators of the aerosol generating device of FIG. 4; and

FIG. 12 shows a schematic view of a third embodiment of an array of aerosol generators of the aerosol generating device of FIG. 4.

### DETAILED DESCRIPTION

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

An “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol generating material may include any plant based material, such as any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50wt%, 60wt% or 70wt% of amorphous solid, to about 90wt%, 95wt% or 100wt% of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilise at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporise an aerosol generating material in the form of a liquid, which may or may not contain nicotine. The aerosol generating material may be in the form of or be provided as part of a rod, cartridge or cassette or the like which can be inserted into the apparatus. A heater for heating and volatilising the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

In the following discussions of the accompanying drawings, where the same element is present in a more than one embodiment the same reference numeral is used for that element throughout, where there are similar elements similar reference numerals (the same numeral plus a multiple of 100) are used.

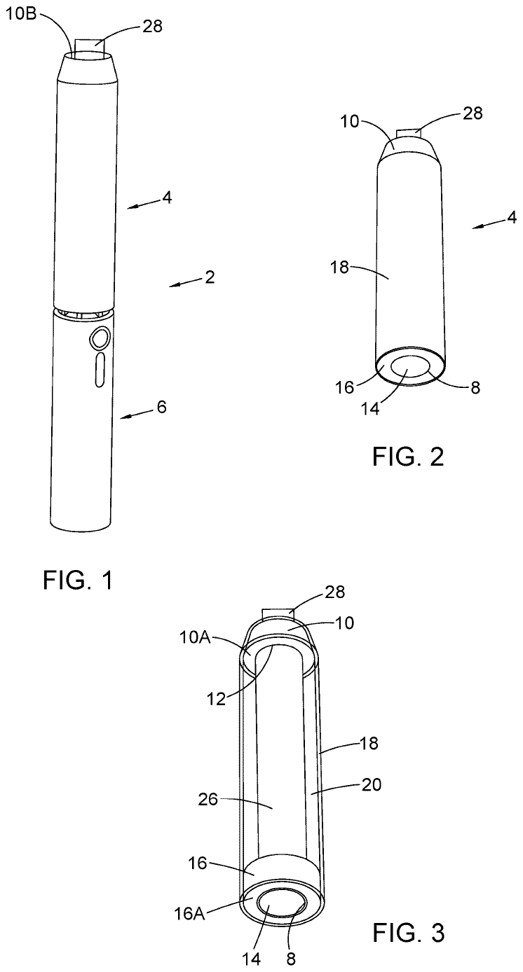

With reference to FIG. 1, an aerosol generating system 2 is comprised of an article (also known as a consumable) 4 and an aerosol generating device 6.

With reference to FIGS. 2 and 3, the article 4 includes a central cylindrical hollow core 8 with a coating of aerosol generating material 26. The core 8 is formed from a material that can support the coating of aerosol generating material 26 on the radially outer face of the core 8. In some examples, the core 8 is formed of a metal or metal alloy sheet material, for example aluminium foil. The aerosol generating material 26 forms a continuous and uniform coating on the outer surface of the core 8. The hollow core 8 defines a hollow passage which is so dimensioned that the core 8 is a sliding fit over the aerosol generating rod 24 of the aerosol generating device 6 which is described below. In other non-illustrated embodiments there may be a lap seam or other seam in the aerosol generating material as a result of the method of manufacture of the article. All such constructions fall within the scope of the present invention.

A first end 12 of the core 8 is within an aperture extending at least partially through a truncated-conical first end element 10. The first end 12 of the core 8 is fixed within that aperture by friction, a physical fixing means, and/or an adhesive. Extending from the first end 12 in a direction away from the core 8 is a mouthpiece 28.

The second end 14 of the core 8 is fixed within in an aperture which extends through a cylindrical second end element 16. The second end 14 of the core 8 is fixed within that aperture by friction, a physical fixing means and/or an adhesive. The second end of the core 8 mouths through an end surface 16A of the second end element 16 so that access to the inside of the hollow core 8 may be gained through that mouth.

Supported on the radially outermost portions of the first and second end elements 10, 16 and extending between those outermost portions of the end elements 10, 16 is a cylindrical shell 18. An air passage 20 is defined by the radially outer surface of the aerosol generating material 26 on core 8 and the radially inner surface of the shell 18.

The second end element 16 includes one or more passages (not shown) which extend between the face 16A of the second end element 16 and the air passage 20.

The first end element 10 includes one or more passages (not shown) which extend between the face 10A of the first end element 10 and the mouthpiece 28 extending from the face 10B. There is thus created at least one air passage that passes from end face 16A through end element 16, along air passage 20, through end element 10, into mouthpiece 28 and out of an aperture (not shown) in the mouthpiece 28.

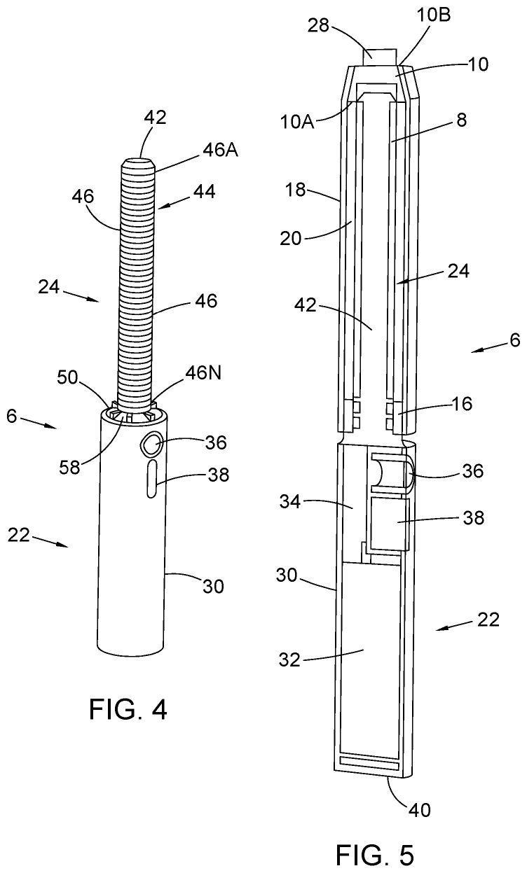

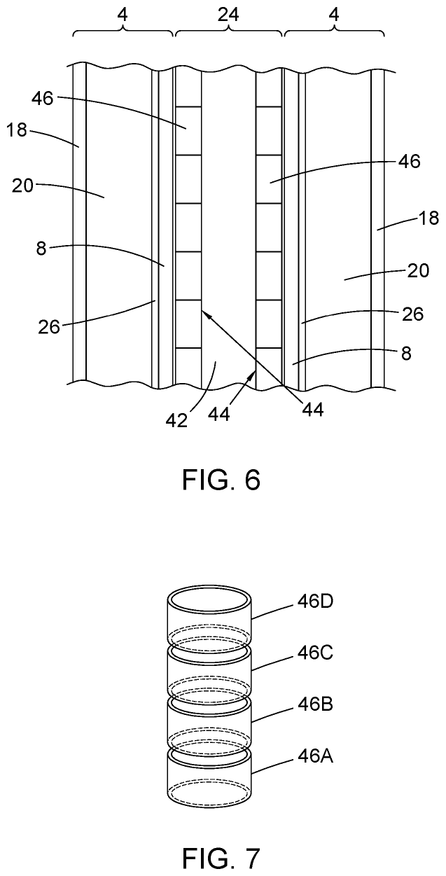

With reference to FIGS. 4 and 5, the aerosol generating device 6 is comprised of a handle 22 and an aerosol generating rod 24. The handle 22 includes an outer skin 30 which defines an inner space. Within that inner space is located a power source 32, for example a rechargeable battery, and a control unit 34. Set into the skin 30 is an input device 36 which, in the illustrated embodiment, is a push button. Also set into the skin 30 is a display device 38. The control unit 34, power source 32, input device 36, and display 38 are all electrically connected by suitable electrical connection means, for example wires.

The skin 30 includes a closed end 40, and an opposite end from which extends the aerosol generating rod 24.

The aerosol generating rod 24 includes a base 48, a longitudinally extending cylindrical support rod 42 and an array 44 of aerosol generators 46 (for clarity not all of the aerosol generators 46 are labelled). The array 44 or the aerosol generators 46 are attached to the axially extending surface of the support rod 42.

The base 48 is configured to engage with the end of the skin 30 which is opposite to the closed end 40. The base 48 includes one or more ribs or other upstanding features 50 which are so dimensioned and located that they prevent the face 16A of the second end element 16 from contacting the main part of the base 48 when the hollow core 8 of article 4 is located on the aerosol generation rod 24. This ensures that the above discussed one or more air passages through the second element end 16 are not blocked when the article 4 is located on the aerosol generation rod 24.

Each aerosol generator 46 is electrically connected to the control unit 34 by suitable electrical connection means (not shown), for example wires.

In a first embodiment of the aerosol generation rod 24, each of the aerosol generators 46 is a ring and comprises a resistance heater material. In the first embodiment each aerosol generator 46 is of the same dimension as each other aerosol generator 46. For illustrative purposes a small number of those aerosol generators 46 are shown in FIG. 7. The aerosol generation rod 24 may include a larger or smaller number of aerosol generators 46 than illustrated in FIG. 7. The aerosol generators 46 are positioned end to end to form a cylinder around the support rod 42 thus forming an array of aerosol generators 46 which is a plurality of aerosol generators 46 in the longitudinal direction and one aerosol generator 46 in the lateral direction (which is perpendicular to the longitudinal direction).

The number of aerosol generators 46 and the dimensions of each aerosol generator 46 may be at least partially determined by the longitudinal dimension of the support rod 42 and the amount of aerosol to be generated per unit surface area of each aerosol generator 46.

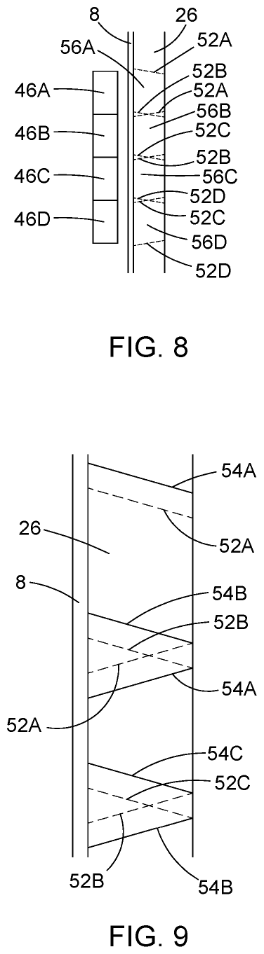

With reference to FIGS. 8 and 9, the aerosol generators 46 in the array 44 are so positioned relative to each other that when each aerosol generator 46 is fully activated that aerosol generator 46 will cause the aerosolation of generation area 56 of aerosol generating material 26 which is shown as bounded by dashed lines 52. Thus when aerosol generator 46A is fully activated the aerosol generation area 56A of aerosol generating material 26 that is aerosolized is bounded by lines 52A, when aerosol generator 46B is fully activated the aerosol generation area 56B of aerosol generating material 26 that is aerosolized is bounded by lines 52B etc. The aerosol generators 46 are so positioned relative to each other that the aerosol generation areas 56 of aerosol generating material 26 aerosolized by adjacent aerosol generators 46 overlap each other. This has the effect of maximizing the quantity of the aerosol generating material 26 that is aerosolized.

In some embodiments of the present disclosure, in addition to aerosolizing the aerosol generating material 26 in generation areas 56, the full activation of an aerosol generator 46 warms a further portion of aerosol generating material 26 that is adjacent to the aerosol generating material 26 that is being aerosolized. That area is shown as being bounded by the lines 54 in FIG. 9.

In some embodiments, the controller 34 may cause one or more aerosol generators 46 to become partially activated. In the partial activation mode the aerosol generators 46 may warm but not aerosolize the aerosol generating material 26 in the generation area 56 and possibly in the area bounded by lines 54.

In some embodiments, each aerosol generator 46 comprises a resistive heating generator including components to heat the aerosol generator 46 via a resistive heating process. In this embodiment, an electrical current is directly applied to a resistive aerosol generator 46, and the resulting flow of current in the aerosol generator 46 causes the aerosol generator 46 to be heated by Joule heating. The aerosol generator 46 comprises resistive material configured to generate heat when a suitable electrical current passes through it, and the aerosol generating device 6 comprises electrical contacts for supplying electrical current to the aerosol generators 46. The resistive material may be coated with a suitable dielectric to prevent short circuits to the article 4.

In some examples, in use, each aerosol generator 46 is configured to heat, when fully activated, to a temperature of between about 200° C. and about 350° C., such as between about 240° C. and about 300° C., or between about 250° C. and about 280° C.

In some alternative embodiments each aerosol generator 46 comprises an etched film heater.

In some alternative embodiments each aerosol generator 46 comprises a magnetic field generator and the core 8 is a susceptor. The magnetic field generator is configured to generate one or more varying magnetic fields that penetrate the article 4 so as to cause heating in the core 8. The magnetic field generator includes an inductor coil arrangement (not shown). The inductor coil arrangement comprises an inductor coil (not shown), acting as an inductor element. The inductor coil may be a helical coil, however other arrangements are envisaged. In some embodiments, the inductor coil arrangement comprises two or more inductor coils. The two or more inductor coils in such embodiments are disposed adjacent to each other and may be aligned co-axially along the axis.

The core 8/susceptor may include one or more lines of perforations matching the boundaries of the generation areas 56 which will assist in limiting the inductive heating of the core 8 to that part of the core 8 which is overlaid by the generation area 56 that the aerosol generator is associated with.

In some examples, in use, the magnetic field generator is configured to heat the core 8 to a temperature of between about 200° C. and about 350° C., such as between about 240° C. and about 300° C., or between about 250° C. and about 280° C.

The inductor coil may be a helical coil comprising electrically-conductive material, such as copper. The coil is formed from wire, such as Litz wire, which is wound helically around a support member. The coil defines a generally tubular shape. The inductor coil has a generally circular profile. In other embodiments, the inductor coil may have a different shape, such as generally square, rectangular or elliptical. The coil width may increase or decrease along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximised. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

In an embodiment of the present disclosure the array 44 of aerosol generators 46 extends in a longitudinal direction between a first longitudinal end and a second longitudinal end of the aerosol generation rod 24. In the aerosol generating device 6 shown in FIG. 4 the first longitudinal end of the aerosol generation rod 24 is remote from the handle 22, and the second longitudinal end is adjacent the handle 22.

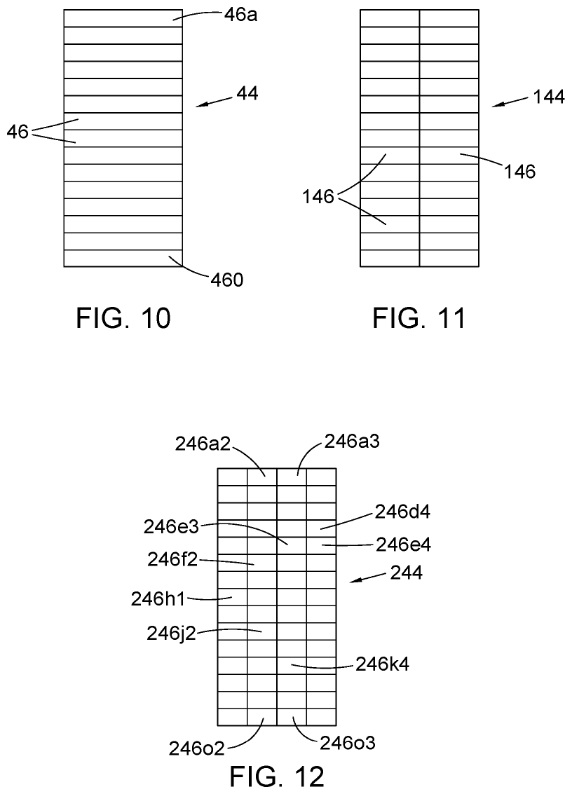

With further reference to the array 44 of aerosol generators 46, the array 44 may be most easily considered as if it were projected onto a plane rather than extending around the aerosol generating rod 24. The array 44 may then be depicted as shown in FIG. 10.

In some embodiments the array 144 of aerosol generators 146 has the form of an array that comprises a plurality of aerosol generators 146 in both the longitudinal direction and the lateral direction. FIG. 11 shows an example of an array 144 that is fifteen aerosol generators 146 longitudinally and two aerosol generators 146 laterally. FIG. 12 shows an example of an array 244 that is fifteen aerosol generators 246 longitudinally and four aerosol generators 246 laterally. It will be appreciated that other arrays may be used and fall within the scope of the present invention.

In some embodiments the array 44, 144, 244 comprises at least one printed circuit board supporting a plurality of individually heatable circuits. Each aerosol generator 46, 146, 246 is comprised of at least one of those circuits. In such embodiments the printed circuit board or boards may be attached to the support rod 42. Alternatively the circuit boards may have sufficient rigidity that the aerosol generation rod 24 may be formed from the circuit board or boards.

In some embodiments at least one of the printed circuit boards comprises a flexible printed circuit board. In such an embodiment the circuit board can be rolled into a tube and either supported on a support rod 42 or form the aerosol generation rod 24.

The controller 34 is adapted to control the order in which the aerosol generators 46, 146, 246 are activated, and their activation generally.

The functionality of the controller 34 of the aerosol generation device 6, and as such the method of operation of the aerosol generation device 6 are described below.

In some embodiments the controller 34 fully activates the aerosol generators 46, 146, 246 sequentially from a first aerosol generator, for example aerosol generator 46a (as seen in FIG. 4 or FIG. 10) at a first position on the array 44 to an aerosol generator 46o at a second position on the array 44.

In some embodiments the aerosol generators 46, 146, 246 are activated one at a time.

In some embodiments the controller may cause a different non-zero number of aerosol generators 46, 146, 246 to activate at a particular step in the sequence. For example at the first step in the sequence the controller may cause two aerosol generators 46, 146, 246 to be fully activated at the same time, and subsequent steps may cause only one aerosol generator 46, 146, 246 to be activated at each step in the sequence.

The number of aerosol generators 46, 146, 246 the controller activates at any part or step in the sequence is, in some embodiments, dependent on the desired volume of aerosol to be generated at a given part or step in the sequence.

In some embodiments the controller 34 fully activates the aerosol generators 246 sequentially from at least two aerosol generators 246, for example two, at a first position on the array 244 of FIG. 12 to at least two aerosol generators 246, for example two, at a second position on the array. For example from aerosol generators 246a2 and 246a3 to 246o2 and 246o3.

In some embodiments the controller 34 fully activates the aerosol generators 246 between the first and second positions such that in at least one intermediate part or step of the sequence in which the aerosol generators are fully activated there is activation of an aerosol generator, for example 246e4 that is longitudinally closer to the second position on the array 244 than the previously activated aerosol generator, for example 246d4 and laterally in the same position as the previously activated aerosol generator 246d4.

In some embodiments the controller 34 fully activates the aerosol generators 246 between the first and second positions such that in at least one intermediate part or step of the sequence in which the aerosol generators are fully activated there is activation of an aerosol generator, for example 246e3, that is longitudinally at approximately the same distance from the second position on the array (246o2 and 246o3) as the previously activated aerosol generator 246d4 and laterally spaced from the position of the previously activated aerosol generator 246d4.

In some embodiments the controller 34 fully activates the aerosol generators 246 between the first and second positions such that in at least one intermediate part or step of the sequence in which the aerosol generators are fully activated there is activation of an aerosol generator, for example 246f2, that is longitudinally closer to the second position on the array (246o2 and 246o3) than the previously activated aerosol generator 246e3 and laterally spaced from the position of the previously activated aerosol generator 246e3.

In some embodiments the controller 34 fully activates the aerosol generators 246 between the first and second positions such that in at least one intermediate part or step of the sequence in which the aerosol generators are fully activated there is activation of at least two aerosol generators, for example 246f2 and 246f4, that are longitudinally at approximately the same distance from the second position on the array (246o2 and 246o3) as the previously activated aerosol generator 246e3 and laterally spaced from the position of the previously activated aerosol generator 246e3 and each other.

In some embodiments the controller 34 partially activates one or more of the aerosol generators 246 as part of the sequence of fully activating the aerosol generators 46. For example when aerosol generator 246d4 was being fully activated as discussed above, aerosol generator 246e4 would be being partially activated. This will decrease the period of time it takes for aerosol generator 246e4 to cause aerosolation of the aerosol generation area 56 of aerosol generating material 26 associated with aerosol generator 246e4.

In some embodiments the controller 34 comprises a memory (not shown) and a processor (not shown). The memory stores one or more schedules for the full activation of the aerosol generators 46, 146, 246 in the array 44.

In some embodiments a schedule stored in the memory causes the controller 34 to fully activate a first aerosol generator 46, 146, 246 on receipt of a first input received by the controller 34, and to sequentially fully activate all of the remainder of the aerosol generators 46, 146, 246 in a predetermined order until all of the aerosol generators have been fully activated.

In the illustrated aerosol generation device 6 the first input received by the controller is generated by a user activating the input device 36. In some embodiments the input device is a button electronically connected to the controller.

In some embodiments a schedule stored in the memory divides the aerosol generators 46, 146, 246 into a non-zero number (n) of groups of aerosol generators and allocates the groups a number from 1 to n. Each group of aerosol generators 46, 146, 246 contains a non-zero number of aerosol generators 46, 146, 246, and the schedule comprises instructions to cause the controller 34 to fully activate the aerosol generators 46, 146, 246 of group 1 according to a first sub-schedule on receipt of a first input by the controller 34, to fully activate the aerosol generators 46, 146, 246 of group 2 according to a second sub-schedule on receipt of a second input by the controller 34, and to repeat that pattern until the aerosol generators 46, 146, 246 of group n have been fully activated according to an nth sub-schedule on receipt of an nth input by the controller 34.

In some embodiments each of the sub-schedules 1 to n are the same.

In some embodiments the number of aerosol generators 46, 146, 246 in each of groups 1 to n is the same.

In some embodiments a schedule includes instructions relating each individual aerosol generator 46, 146, 246 with a period of time for which that aerosol generator 46, 146, 246 is to be fully activated.

In some embodiments the period of time for which each individual aerosol generator 46, 146, 246 is to be activated is the same.

In some embodiments the aerosol generation device 6 comprises a puff detection means 58. In the illustrated aerosol generation device 6 in FIGS. 4 and 5 the puff detection means 58 is located adjacent the base of the aerosol generation rod 24 so that it can detect a user of the aerosol generating system 2 drawing on the mouthpiece 28. The puff detection means 58 is in electronic communication with the controller 34. The puff detection means 58 is configured to detect a characteristic of a puff by the user and the puff detection means generates an electronic signal on detection of the characteristic of the puff. That electronic signal is transmitted to the controller 34.

In some embodiments the detected characteristic of the puff is one of the start of the puff, the end of the puff, the period of time between the start and end of the puff, the number of puffs per predetermined period of time, the period between puffs, the drop of air pressure at the puff detection means resultant from the puff, the velocity of air passing the puff detection means 58 at a determined time in the period of the puff, and the volume of the puff.

In some embodiments the puff detection means 58 is configured to detect two or more characteristics of the puff and the puff detection means generates a different electronic signal on detection of each characteristic of the puff. All of the electronic signals are transmitted to the controller.

In some embodiments the aerosol generation device 6 comprises a plurality of puff detection means 58 (only one illustrated in the Figures), and each puff detection means 58 is in communication with the controller 34. One of the puff detection means 58 may be located in the air passage 20.

In some embodiments one or more tables are stored in the memory and at least one table relates a characteristic of the puff to a predetermined schedule for the full activation of one or more aerosol generators 46, 146, 246. The controller 34 will then implement a predetermined schedule of activating the aerosol generators 46, 146, 246 in response to receipt of the signal generated by a puff detection means 58 and detection of that characteristic of the puff in the one or more tables.

In some embodiments the predetermined schedule in the table as a result of the receipt of a signal from the puff detection means 58 overrides any schedule that the controller 34 was implementing at the time of receipt of the signal generated by the puff detection means 58.

In some embodiments the aerosol generation device 6 further comprises at least one display element 38, and the controller 34 may cause at least one display element 38 to be activated when an aerosol generator 46, 146, 246 is activated.

In some embodiments the controller 34 may cause at least one display element 38 to display data relating to the operation of the aerosol generation device 6.

In some embodiments the display element 38 is configured to provide a visual representation of a traditional cigarette when the traditional cigarette is burning.

In some embodiments the display element 38 is configured to provide a visual representation of the proportion of the aerosol generating material 26 on the article 4 that has not yet been aerosolized.

To use the aerosol generation device 6 of the present invention an article 4 is located on the aerosol generation rod 24. When the user is ready to begin a user session the user causes the aerosol generation device 6 to commence operation by activating input device 36. The controller 34 receives a signal reflecting the activation of the input device 36 and proceeds to follow a schedule stored in the memory, or a schedule determined in response to detection of one or me characteristics of a user's puff by a puff detection means 58. The controller then functions as described above.

### STATEMENTS

1 An aerosol provision device for generating an aerosol from aerosol generating material, in which the device comprises a plurality of aerosol generators, and a controller, in which
the aerosol generators are disposed adjacent to each other to form an array of aerosol generators;
the device is so configured that the aerosol generating material is positioned to overlie the array of aerosol generators;
each aerosol generator is configured to generate aerosol from a generation area of the aerosol-generating material when the aerosol generator is fully activated; and
the generation areas associated with aerosol generators adjacent to each other in the array abut, partially overlap, or are adjacent to each other.
2 A device according to statement 1 in which the controller is adapted to control the order in which the aerosol generators are activated, and
the controller fully activates the aerosol generators sequentially from the aerosol generator at a first position on the array of aerosol generators to an aerosol generator at a second position on the array of aerosol generators
3 A device according to statement 1 or 2 in which the array of aerosol generators extends in a longitudinal direction between a first longitudinal end and a second longitudinal end.
4 A device according to statement 3 when dependent on statement 2 in which the first position is at the first longitudinal end and the second position at the second longitudinal end.
5 A device according to any of statements 1 to 4 in which each aerosol generator is configured to warm but not aerosolize a warming area of aerosol-generating material when that aerosol generator is fully activated; and
the warming area associated with a given aerosol generator at least partially surrounds the generation area for that aerosol generator.
6 A device according to statement 5 when dependent on statement 2 or statements 3 or 4 when dependent on statement 2 in which the warming area associated with a first aerosol generator at least partially overlies the generation area of a second aerosol generator, in which the second aerosol generator is adjacent to the first aerosol generator and closer to the second position on the array than the first aerosol generator.
7 A device according to any of statements 1 to 6 in which each aerosol generator is configured to warm but not aerosolize the generation area of aerosol-generating material of that aerosol generator when that aerosol generator is partially activated.
8 A device according to any of statements 1 to 7 in which the array of aerosol generators forms a longitudinally extending rod, or the array of aerosol generators is supported on the surface or one or more surfaces of a longitudinally extending support rod to form a longitudinally extending rod.

9 A device according to any of statements 1 to 8 in which the array of aerosol generators has a longitudinal dimension of two or more aerosol generators and a lateral dimension of one aerosol generator.
10 A device according to statement 9 when dependent on statement 8 in which each aerosol generator is formed as a closed loop and configured to extend around a longitudinally extending rod, and optionally the closed loop has one of a circular, elliptical, rectangular, or other polyhedral shape.
11 A device according to any of statements 1 to 8 in which the array of aerosol generators has a longitudinal dimension of two or more aerosol generators and a lateral dimension of two or more aerosol generators.

12 A device according to statement 11 in which the generation areas associated with the aerosol generators abut or partially overlap each other in both the longitudinal and lateral directions.
13 A device according to statement 11 or 12 in which the controller controls the order in which the aerosol generators are activated, and
the controller fully activates the aerosol generators in a sequence from at least one aerosol generator at the first position on the array to at least one aerosol generator at the second position on the array.
14 A device according to statement 13 in which at least one intermediate part of the sequence in which the aerosol generators are fully activated is activation of an aerosol generator that is longitudinally closer to the second position on the array than the previously activated aerosol generator and laterally in the same position as the previously activated aerosol generator.
15 A device according to statement 13 or 14 in which at least one intermediate part of the sequence in which the aerosol generators are fully activated is activation of an aerosol generator that is longitudinally substantially the same distance from the second position on the array as the previously activated aerosol generator and laterally spaced from the position of the previously activated aerosol generator.
16 A device according to any of statements 13 to 15 in which at least one intermediate part of the sequence in which the aerosol generators are fully activated is activation of an aerosol generator that is longitudinally closer to the second position on the array than the previously activated aerosol generator and laterally spaced from the position of the previously activated aerosol generator.
17 A device according to any of statements 2, or 3 to 12 when dependent on statement 2 in which the controller further controls the number of aerosol generators that are fully activated at any given time.
18 A device according to statement 13 in which the controller further controls the number of aerosol generators that are fully activated at any given time, and at least one intermediate part of the sequence comprises one or more of the intermediate parts of the sequence of any of statements 14 to 16.
19 A device according to any of statements 13 to 18 when dependent on statement 7 in which the controller is configured to partially activate one or more aerosol generators as part of the sequence of fully activating the aerosol generators.
20 A device according to any of statements 1 to 19 in which the array of aerosol generators comprises at least one printed circuit board supporting a plurality of individually heatable circuits.
21 A device according to statement 20 in which at least one of the printed circuit boards comprises a flexible printed circuit board.
22 A device according to any of statements 1 to 21 in which at least one of the aerosol generators comprises an electrical resistance heater.
23 A device according to any of statements 1 to 21 in which at least one of the aerosol generators comprises an etched film or a printed film heater.
24 A device according to any of statements 1 to 23 in which at least one of the aerosol generators comprises an induction coil.
25 A device according to any of statements 1 to 24 in which the controller comprises a memory and a processor, and one or more schedules for the full activation of the aerosol generators in the array of aerosol generators are stored in the memory.
26 A device according to statement 25 in which a schedule stored in the memory causes the controller to fully activate a first aerosol generator on receipt of a first input by the controller, and to sequentially fully activate all of the remainder of the aerosol generators in a predetermined order until all of the aerosol generators have been fully activated.
27 A device according to statement 25 in which a schedule stored in the memory divides the aerosol generators into a non-zero number (n) of groups of aerosol generators and allocates the groups a number from 1 to n, in which each group of aerosol generators contains a non-zero number of aerosol generators, and the schedule comprises instructions to cause the controller to fully activate the aerosol generators of group 1 according to a first sub-schedule on receipt of a first input by the controller, to fully activate the aerosol generators of group 2 according to a second sub-schedule on receipt of a second input by the controller, and to repeat that pattern until the aerosol generators of group n have been fully activated according to an nth sub-schedule on receipt of an nth input by the controller.
28 A device according to statement 27 in which each of the sub-schedules 1 to n are the same.
29 A device according to statement 27 or 28 in which the number of aerosol generators in each of groups 1 to n is the same.
30 A device according to any of statements 25 to 29 in which the schedule includes instructions relating each individual aerosol generator with a period of time for which that aerosol generator is to be fully activated.
31 A device according to statement 30 in which the period of time for which each individual aerosol generator is activated is the same.
32 A device according to any of statements 1 to 31 in which the device comprises a puff detection means, the puff detection means is in communication with the controller, the puff detection means is configured to detect a characteristic of a puff, the puff detection means is configured to generate a signal on detection of the characteristic of the puff, and the signal is transmitted to the controller.
33 A device according to statement 32 which the detected characteristic of the puff is one of the start of the puff, the end of the puff, the period of time between the start and end of the puff, the number of puffs per predetermined period of time, the period between puffs, the drop of air pressure at the puff detection means resultant from the puff, the velocity of air passing the puff detection means at a determined time in the period of the puff, and the volume of the puff.
34 A device according to statement 32 or 33 in which the puff detection means is configured to detect two or more characteristics of the puff, the puff detection means is configured to generate a different signal on detection of each characteristic of the puff, and the signals are transmitted to the controller.
35 A device according to any of statements 32 to 34 in which the device comprises a plurality of puff detection means, and each puff detection means is in communication with the controller.
36 A device according to any of statements 32 to 35 when dependent on any of statements 25 to 31 in which one or more tables are stored in the memory, at least one table relates a characteristic of the puff to a predetermined schedule for the full activation of one or more aerosol generators, and the controller implements the predetermined schedule in response to receipt of the signal generated by the puff detection means and detection of that characteristic of the puff in the one or more of the tables.
37 A device according to statement 36 in which the predetermined schedule overrides any schedule that the controller was implementing at the time of receipt of the signal generated by the puff detection means.
38 A device according to any of statements 1 to 37 in which the device further comprises at least one display element, and the controller may cause at least one display element to be activated when an aerosol generator is activated.
39 A device according to statement 38 in which the controller may cause at least one display element to display data relating to the operation of the device.
40 A device according to statement 38 or 39 in which the display element is configured to provide a visual representation of a traditional cigarette when the traditional cigarette is burning.
41 A device according to any of statements 38 to 40 in which the display element is configured to provide a visual representation of the proportion of the aerosol generating material that has not yet been aerosolized.
42 An aerosol generating system comprising an aerosol provision device according to any of statements 1 to 41 and an article, in which the article comprises aerosol-generating material.
43 A method of generating aerosol from an article comprising an aerosol-generating material using an aerosol-generating device in which the aerosol provision device comprises a plurality of aerosol generators, and a controller;
the aerosol generators are disposed adjacent to each other to form an array of aerosol generators;
the device is configured to cause the aerosol generating material to overlie the array of aerosol generators;
each aerosol generator generates aerosol from a generation area of aerosol-generating material when the aerosol generator is fully activated; and
the generation areas associated with the aerosol generators abut, partially overlap, or are adjacent to each other.
44 A method according to statement 43 in which the controller controls the order in which the aerosol generators are activated, and
the controller fully activates the aerosol generators sequentially from an aerosol generator at a first position on the array of aerosol generators to an aerosol generator at a second position on the array of aerosol generators.
45 A method according to statement 43 or 44 in which the array of aerosol generators extends in a longitudinal direction between a first longitudinal end and a second longitudinal end.
46 A method according to statement 45 when dependent on statement 44 in which the first position is at the first longitudinal end and the second position at the second longitudinal end.
47 A method according to any of statements 43 to 46 in which each aerosol generator warms but does not aerosolize a warming area of aerosol-generating material when that aerosol generator is fully activated; and
the warming area associated with a given aerosol generator at least partially surrounds the generation area for that aerosol generator.
48 A method according to statement 47 when dependent on statement 44 or statements 45 or 46 when dependent on statement 44 in which the warming area associated with a first aerosol generator at least partially overlies the generation area of a second aerosol generator, in which the second aerosol generator is adjacent to the first aerosol generator and closer to the second position on the array than the first aerosol generator.
49 A method according to any of statements 43 to 48 in which each aerosol generator warms but does not aerosolize the generation area of aerosol-generating material of that aerosol generator when that aerosol generator is partially activated.
50 A method according to any of statements 43 to 49 in which the array of aerosol generators forms a longitudinally extending rod, or the array of aerosol generators is supported on the surface or one or more surfaces of a longitudinally extending support rod to form a longitudinally extending rod.
51 A method according to any of statements 43 to 50 in which the array of aerosol generators has a longitudinal dimension of two or more aerosol generators and a lateral dimension of one aerosol generator.
52 A method according to statement 51 when dependent on statement 50 in which each aerosol generator is formed as a closed loop configured to extend around the longitudinally extending rod, and optionally the closed loop has one of a circular, elliptical, rectangular, or other polyhedral shape.
53 A method according to any of statements 43 to 50 in which the array of aerosol generators has a longitudinal dimension of two or more aerosol generators and a lateral dimension of two or more aerosol generators.
54 A method according to statement 53 in which the generation areas associated with the aerosol generators abut or partially overlap each other in both the longitudinal and lateral directions.
55 A method according to statement 53 or 54 in which the controller controls the order in which the aerosol generators are activated, and the controller fully activates the aerosol generators in a sequence from at least one aerosol generator at the first position on the array to at least one aerosol generator at the second position on the array.
56 A method according to statement 55 in which at least one intermediate part of the sequence in which the aerosol generators are fully activated is activation of an aerosol generator that is longitudinally closer to the second position on the array than the previously activated aerosol generator and laterally in the same position as the previously activated aerosol generator.
57 A method according to statement 55 or 56 in which at least one intermediate part of the sequence in which the aerosol generators are fully activated is activation of an aerosol generator that is longitudinally substantially the same distance from the second position on the array as the previously activated aerosol generator and laterally spaced from the position of the previously activated aerosol generator.
58 A method according to any of statements 55 to 57 in which at least one intermediate part of the sequence in which the aerosol generators are fully activated is activation of an aerosol generator that is longitudinally closer to the second position on the array than the previously activated aerosol generator and laterally spaced from the position of the previously activated aerosol generator.
59 A method according to any of statements 44, or statements 45 to 54 when dependent on statement 44 in which the controller further controls the number of aerosol generators that are fully activated at any given time.
60 A method according to statement 55 in which the controller further controls the number of aerosol generators that are fully activated at any given time, and at least one intermediate part of the sequence comprises one or more of the intermediate parts of the sequence of any of statements 56 to 58.
61 A method according to any of statements 55 to 60 when dependent on statement 49 in which the controller partially activates one or more aerosol generators as part of the sequence of fully activating the aerosol generators.
62 A method according to any of statements 43 to 61 in which the array of aerosol generators comprises at least one printed circuit board supporting a plurality of individually heatable circuits.
63 A method according to statement 62 in which at least one of the printed circuit boards comprises a flexible printed circuit board.
64 A method according to any of statements 43 to 63 in which at least one of the aerosol generators comprises an electrical resistance heater.
65 A method according to any of statements 43 to 63 in which at least one of the aerosol generators comprises an etched film heater.
66 A method according to any of statements 43 to 65 in which at least one of the aerosol generators comprises an induction coil.
67 A method according to any of statements 43 to 66 in which the controller comprises a memory and a processor, and one or more schedules for the full activation of the aerosol generators in the array of aerosol generators are stored in the memory.
68 A method according to statement 67 in which a schedule stored in the memory causes the controller to fully activate a first aerosol generator on receipt of a first input by the controller, and to sequentially fully activate all of the remainder of the aerosol generators in a predetermined order until all of the aerosol generators have been fully activated.
69 A method according to statement 67 in which a schedule stored in the memory divides the aerosol generators into a non-zero number (n) of groups of aerosol generators and allocates the groups a number from 1 to n, in which each group of aerosol generators contains a non-zero number of aerosol generators, and the schedule comprises instructions to cause the controller to fully activate the aerosol generators of group 1 according to a first sub-schedule on receipt of a first input by the controller, to fully activate the aerosol generators of group 2 according to a second sub-schedule on receipt of a second input by the controller, and to repeat that pattern until the aerosol generators of group n have been fully activated according to an nth sub-schedule on receipt of an nth input by the controller.
70 A method according to statement 69 in which each of the sub-schedules 1 to n are the same.
71 A method according to statement 69 or 70 in which the number of aerosol generators in each of groups 1 to n is the same.
72 A method according to any of statements 67 to 71 in which the schedule includes instructions relating each individual aerosol generator with a period of time for which that aerosol generator is to be fully activated.
73 A method according to statement 72 in which the period of time for which each individual aerosol generator is to be activated is the same.
74 A method according to any of statements 43 to 73 in which the device comprises a puff detection means, the puff detection means is in communication with the controller, the puff detection means detects a characteristic of a puff, the puff detection means generates a signal on detection of the characteristic of the puff, and the signal is transmitted to the controller.
75 A method according to statement 74 which the detected characteristic of the puff is one of the start of the puff, the end of the puff, the period of time between the start and end of the puff, the number of puffs per predetermined period of time, the period between puffs, the drop of air pressure at the puff detection means resultant from the puff, the velocity of air passing the puff detector at a determined time in the period of the puff, the volume of the puff.
76 A method according to statement 74 or 75 in which the puff detection means detects two or more characteristics of the puff, the puff detection means generates a different signal on detection of each characteristic of the puff, and the signals are transmitted to the controller.
77 A method according to any of statements 74 to 76 in which the device comprises a plurality of puff detection means, and each puff detection means is in communication with the controller.
78 A method according to any of statements 74 to 77 when dependent on any of statements 67 to 73 in which one or more tables are stored in the memory, at least one table relates a characteristic of the puff to a predetermined schedule for the full activation of one or more aerosol generators, and the controller implements the predetermined schedule in response to receipt of a signal generated by a puff detection means on detection of that characteristic of the puff.
79 A method according to statement 78 in which the predetermined schedule overrides any schedule that the controller was implementing at the time of receipt of the signal generated by the puff detection means.
80 A method according to any of statements 43 to 79 in which the device further comprises at least one display element, and the controller may cause at least one display element to be activated when an aerosol generator is activated.
81 A method according to statement 80 in which the controller may cause at least one display element to display data relating to the operation of the device.
82 A method according to statement 80 or 81 in which the display element provides a visual representation of a traditional cigarette when the traditional cigarette is burning.
83 A method according to any of statements 80 to 82 in which the display element provides a visual representation of the proportion of the aerosol generating material that has not yet been aerosolized.

The above description is meant to be exemplary only, and one skilled in the art will recognize that changes may be made to the embodiments described without departing from the scope of the disclosure. Still other modifications which fall within the scope of the present disclosure will be apparent to those skilled in the art, in light of a review of this disclosure.

Various aspects of the aerosol provision device, aerosol provision system, and method of using that device disclosed in the various embodiments may be used alone, in combination, or in a variety of arrangements not specifically discussed in the embodiments described above. This disclosure is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. An aerosol provision device for generating an aerosol from aerosol generating material, in which the device comprises a plurality of aerosol generators, and a controller, in which:
the aerosol generators are disposed adjacent to each other to form an array of aerosol generators;
the device is so configured that the aerosol generating material is positioned to overlie the array of aerosol generators;
each aerosol generator is configured to generate aerosol from a generation area of the aerosol-generating material when the aerosol generator is fully activated; and
the generation areas associated with aerosol generators adjacent to each other in the array abut, partially overlap, or are adjacent to each other.

2. The device according to claim 1, in which the controller is adapted to control the order in which the aerosol generators are activated, and
the controller fully activates the aerosol generators sequentially from the aerosol generator at a first position on the array of aerosol generators to an aerosol generator at a second position on the array of aerosol generators.

3. The device according to claim 1, in which the array of aerosol generators extends in a longitudinal direction between a first longitudinal end and a second longitudinal end, and optionally the first position is at the first longitudinal end and the second position at the second longitudinal end.

4. The device according to claim 1, in which each aerosol generator is configured to warm but not aerosolize a warming area of aerosol-generating material when that aerosol generator is fully activated; and
the warming area associated with a given aerosol generator at least partially surrounds the generation area for that aerosol generator.

5. The device according to claim 3, in which the warming area associated with a first aerosol generator at least partially overlies the generation area of a second aerosol generator, in which the second aerosol generator is adjacent to the first aerosol generator and closer to the second position on the array than the first aerosol generator.

6. The device according to claim 1, in which the array of aerosol generators forms a longitudinally extending rod, or the array of aerosol generators is supported on the surface or one or more surfaces of a longitudinally extending support rod to form a longitudinally extending rod.

7. The device according to claim 1, which the array of aerosol generators has a longitudinal dimension of two or more aerosol generators and a lateral dimension of one aerosol generator and optionally each aerosol generator is formed as a closed loop and configured to extend around a longitudinally extending rod, and optionally the closed loop has one of a circular, elliptical, rectangular, or other polyhedral shape.

8. The device according to claim 1, in which the array of aerosol generators has a longitudinal dimension of two or more aerosol generators and a lateral dimension of two or more aerosol generators.

9. The device according to claim 8, in which the generation areas associated with the aerosol generators abut or partially overlap each other in both the longitudinal and lateral directions.

10. (canceled)

11. The device according to claim 7, in which the controller is configured to partially activate one or more aerosol generators as part of the sequence of fully activating the aerosol generators.

12. The device according to claim 1, in which the array of aerosol generators comprises at least one printed circuit board supporting a plurality of individually heatable circuits.

13. (canceled)

14. (canceled)

15. The device according to claim 1, in which the controller comprises a memory and a processor, and one or more schedules for the full activation of the aerosol generators in the array of aerosol generators are stored in the memory.

16. The device according to claim 15, in which a schedule stored in the memory causes the controller to fully activate a first aerosol generator on receipt of a first input by the controller, and to sequentially fully activate all of the remainder of the aerosol generators in a predetermined order until all of the aerosol generators have been fully activated.

17. (canceled)

18. The device according to claim 1, in which the device comprises a puff detection means, the puff detection means is in communication with the controller, the puff detection means is configured to detect a characteristic of a puff, the puff detection means is configured to generate a signal on detection of the characteristic of the puff, and the signal is transmitted to the controller.

19. The device according to claim 18, in which the detected characteristic of the puff is one of the start of the puff, the end of the puff, the period of time between the start and end of the puff, the number of puffs per a predetermined period of time, the period between puffs, the drop of air pressure at the puff detection means resultant from the puff, the velocity of air passing the puff detection means at a determined time in the period of the puff, and the volume of the puff.

20. (canceled)

21. An aerosol generating system comprising an aerosol provision device according to claim 1 and an article, in which the article comprises aerosol-generating material.

22. A method of generating aerosol from an article comprising an aerosol-generating material using an aerosol-generating device in which the aerosol provision device comprises a plurality of aerosol generators, and a controller;
the aerosol generators are disposed adjacent to each other to form an array of aerosol generators;
the device is configured to cause the aerosol generating material to overlie the array of aerosol generators;
each aerosol generator generates aerosol from a generation area of aerosol-generating material when the aerosol generator is fully activated; and
the generation areas associated with the aerosol generators abut, partially overlap, or are adjacent to each other.

23. The method according to claim 22, in which the controller controls the order in which the aerosol generators are activated, and
the controller fully activates the aerosol generators sequentially from an aerosol generator at a first position on the array of aerosol generators to an aerosol generator at a second position on the array of aerosol generators.

24. The method according to claim 22, in which the array of aerosol generators comprises at least one printed circuit board supporting a plurality of individually heatable circuits.

25. The method according to claim 24, in which at least one of the printed circuit boards comprises a flexible printed circuit board.
